(19) United States
(12) Patent Application Publication
(10) Pub. No.: US 2008/0126191 A1
(43) Pub. Date: May 29, 2008

(54) SYSTEM AND METHOD FOR TAGGING, SEARCHING FOR, AND PRESENTING ITEMS CONTAINED WITHIN VIDEO MEDIA ASSETS

(76) Inventor: Richard Schiavi, Honolulu, HI (US)

Correspondence Address: Leighton K. Chong;Godbey Griffiths Reiss & Chong, Pauahi Tower, Suite 2300, 1001 Bishop Street, Honolulu, HI, 96813, US

(21) Appl. No.: 11/557,915

(22) Filed: Nov. 8, 2006

(51) Int. Cl. G06F 17/00; G06Q 30/00

(52) U.S. Cl. 705/14; 707/104.1; 707/E17.019

(57) ABSTRACT

A system and method for computerized searching for items of interest contained in visual media assets, such as a movie or video, stores digital tag information for tagged visual media assets which includes for each tag a time code for a representative image frame, an address code for the storage location of a captured image-still of the frame, and one or more keywords representing the item(s) of interest or their characteristics. When a search request is entered with keywords for items of interest, the search result lists entries from tags containing those keywords, and can also display the captured image-stills (or thumbnail photos thereof) as a visual depiction of the search results. The search service enables advertisers and vendors to bid on rights to link their advertising and other information displays to the search results. The search service can also be used for playback of clips from media assets to viewers on a video viewing website or on a networked playback device.

### TECHNICAL FIELD

This invention generally relates to a computerized system and method for tagging, searching for and presenting content contained in video media files, and more particularly, to a tagging method in which products or items of interest appearing in a video are identified, and a search/display method in which the products or items are found in a search for display to and purchase by the user.

### BACKGROUND OF INVENTION

Many systems have been proposed for tagging video media files so that they can be searched and retrieved from a video media database. For example, U.S. Pat. No. 5,600,775 issued on Feb. 4, 1997 to King, et al., discloses a method and apparatus for annotating full motion video and other indexed data structures. U.S. Pat. No. 6,956,593 issued on Oct. 18, 2005 to Gupta, et al., discloses a user interface for creating, viewing and temporally positioning annotations for media content. U.S. Pat. No. 6,546,405 issued on Apr. 8, 2003 to Gupta, et al., discloses methods for annotating time-based multimedia content. U.S. Pat. No. 6,487,564 issued on Nov. 26, 2002 to Asai, et al., discloses a multimedia-playing apparatus utilizing synchronization of scenario-defined processing time points with playing of finite-time monomedia item. U.S. Pat. No. 6,311,189 issued on Oct. 30, 2001 to deVries, et al., discloses a technique for matching a query to a portion of media. U.S. Pat. No. 6,332,144 issued on Dec. 18, 2001 to deVries, et al., discloses techniques for annotating media including video.

While the prior proposals provide various ways to tag or annotate frames or segments of video with keywords or various types of content descriptors, none of them provides a method for tagging video files to enable identification of products or other items of interest appearing in the video frame or segment being tagged, and then enable the products or items to be readily searched for and displayed in advertising to and/or purchase by the user.

### SUMMARY OF INVENTION

In accordance with a first aspect of the present invention, a method for tagging a time-dependent visual media asset such as a movie, video, or other visual media file for search and retrieval comprises:

(a) playing back the visual media asset in a time-dependent domain in which a series of time codes identifies corresponding time positions of respective image frames of the visual media asset;

(b) identifying a frame of set of frames of the visual media asset to be tagged with a corresponding time code for at least a starting time position thereof;

(c) capturing an image-still of the identified frame or one of the set of frames for visual depiction of content contained in the frame or set of frames to be tagged;

(d) storing the captured image-still at an address location of a storage repository, and returning an address code for the storage address location;

(e) annotating the content depicted in the captured image-still with one or more keywords representing one or more items or characteristics of items therein; and

(f) storing a tag for the frame or frames as digital tag information for the visual media asset, wherein said tag includes the time code for at least the starting time position thereof, an address code for the storage address location of the captured image-still of the frame or set of frames, and one or more keywords representing one or more items or characteristics of items of content in the captured image-still.

In accordance with another aspect of the present invention, a method for computerized searching for items of interest in time-dependent visual media assets, such as a movie, video, or other visual media file, which are tagged with digital tag information comprises:

(a) storing tags with digital tag information for each respective frame or set of frames of the visual media assets tagged as being of interest for searching, wherein each tag includes the time code for at least a starting time position thereof, an address code for a storage address location of a captured image-still of the frame or set of frames, and one or more keywords representing one or more items or characteristics of items of content in the captured image-still;

(b) entering a search request to search the stored digital tag information for the tagged visual media assets using one or more keywords for items of interest in the visual media assets to be searched;

(c) displaying a search result listing entries for those tags found containing keyword(s) for items in the visual media assets corresponding to keyword(s) of the search request, and providing means for viewing the captured image-stills for the respective tags listed as entries of the displayed search result.

A further aspect of the invention is a method for conducting an advertising service on a network connected to one of more users with respect to product items of interest contained in time-dependent visual media assets, such as a movie, video, or other visual media file, which are tagged with digital tag information comprising:

(a) storing tags with digital tag information in an associated data repository for each respective frame or set of frames of the visual media assets tagged as containing product items of interest for searching, wherein each tag includes the time code for at least a starting time position thereof, an address code for a storage address location of a captured image-still of the frame or set of frames, and one or more keywords representing one or more product items or characteristics of product items of content in the captured image-still;

(b) enabling product advertisers and/or vendors to link advertisements and other information for product items of interest contained in the tagged visual media assets;

(c) receiving a search request to search the stored digital tag information for the tagged visual media assets using one or more keywords for product items of interest in the visual media assets to be searched; and

(d) displaying a search result listing entries for those tags found containing keyword(s) for product items in the visual media assets corresponding to keyword(s) of the search request, including displaying thumbnail photos generated from the captured image-stills and links to advertisements other information for product items of interest contained in the tagged visual media assets listed in the search results.

When tagging a video media asset in playback, a video frame or segment containing one or more items of interest is identified, and a time code for the starting frame is retained. The tagged video frame or segment of the video media asset can thereafter be readily found and played back from the time code of the starting frame. Also, an image-still of a representative frame of the video is captured and stored at a storage address location of an associated database, and the storage address location code is retained with the digital tag information. Further, one or more keywords representing the item(s) of interest or their characteristic(s) are added to the tag, so that the tag entry for the item(s) can be found by simple keyword searching. In this manner, the digital tag information can be kept to a small size for quick and easy searching, and furthermore can be maintained as an all-text file, which avoids the problem of having to maintain the digital tag information in mixed file types and also speeds the transmission of the digital tag information to a user device, particularly a mobile user device having a small memory capacity and a thin browser client.

When a search request is entered with keywords for items of interest in the visual media assets, the search result lists entries from the tags containing those keywords and can also display the captured image-stills (or thumbnail photos thereof) as a visual depiction of the search results. In a preferred embodiment, the search method is configured as a web service provided from a server on a network connected to one or more users, and having a data repository for storage of the digital tag information for tagged visual media assets. The web service can include an advertising service for advertisers and vendors of product items of interest in the content of the visual media assets. The advertising service enables the advertisers and vendors to display their advertisements and other information in conjunction with search results returned in response to search requests from users on the network. The advertisers and vendors can bid for the rights to display their advertisements and other information in conjunction with search results returned in response to search requests from users on the network.

The web service can include ancillary services such as a meta tag service for enabling third party entities to produce digital tag information for the visual media assets for storage in the server's data repository. It can also include an image generator service for generating a captured image-still for the digital tag information of a frame or set of frames of a visual media asset in response to a tag request of a user. It can also provide a search service for playback of clips from media assets to viewers on a video viewing website or on a networked playback device.

Other objects, features, and advantages of the present invention will be explained in the following detailed description of the invention having reference to the appended drawings.

### BRIEF DESCRIPTION OF DRAWINGS

FIG. 1 shows a process flow for the tagging phase in accordance with the present invention.

FIG. 2 shows a process flow for the showing (search/display) phase of the invention.

FIG. 3 illustrates the tagging and showing phases performed through a web-based service.

FIG. 4 illustrates the tagging web service employed for an advertisement search/display business model.

FIG. 5 illustrates an example of search results conducted with a preferred type of AdService application.

### DETAILED DESCRIPTION OF INVENTION

In the following detailed description, certain preferred embodiments are described as illustrations of the invention in a specific application, network, or computer environment in order to provide a thorough understanding of the present invention. However, it will be recognized by one skilled in the art that the present invention may be practiced in other analogous applications or environments and with other analogous or equivalent details. Those methods, procedures, components, or functions which are commonly known to persons in the field of the invention are not described in detail as not to unnecessarily obscure a concise description of the present invention.

Some portions of the detailed description which follows are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “computing” or “translating” or “calculating” or “determining” or “displaying” or “recognizing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Aspects of the present invention, described below, are discussed in terms of steps executed on a computer system. Aspects of the present invention are also discussed with respect to an Internet system including electronic devices and servers coupled together within the Internet platform. A “server” and a “mobile device” or “user” can be implemented as a general purpose computer system. Although a variety of different computer systems can be used with the present invention, an exemplary computer system is shown and described in the preferred embodiment.

The invention is further described as implementable in a mobile or wireless data network. Wireless data networks are provided in many countries of the world and allow access to the public Internet or to private data networks through wireless data connection services provided by a carrier to subscribers using mobile wireless devices for communication purposes. Successive new generations of higher speed and greater bandwidth connectivity continue to be developed and commercialized. Mobile wireless devices are expected to become ubiquitous communication devices throughout the world in the future.

In the description below, certain terms are used which may have a specific meaning to those knowledgeable in the industry. These terms are defined as follows:

Tagger—A tagger is a software application and method disclosed in this invention that is used to generate information (tag info) about a Video asset. The tagging software allows the user—which could be a person or another software application—to associate discrete pieces of information to specific portions (or frames, identified by the criteria available for that video decoder SDK), of a media asset. This is called “tagging.”

Player—A player is a software application that sits between the media asset(s) and the host application. The player uses tag information to coordinate action between media assets and applications.

Application—An application is the specific context in which a media asset or set of assets is displayed to a user. The application can consist of graphical user interfaces and software methods.

Repository—A repository stores and retrieves the information generated by a tagger. It also generates new information based on the creation and usage of this information. The repository is a combination of physical hardware and software processes used to store, filter, process, generate and make available information regarding media assets.

Service—The service is a software layer that allows applications to communicate with the repository.

User—A person, group of people, automated process, or set of automated processes interacting with a computing or networked environment.

### Basic Tagging Phase

The system and method of the present invention consists of two basic phases. The tagging phase generates digital tag information about the content of visual media asset to be stored for later searching, and the showing phase enables computerized searching for specific content in the catalogued visual media assets to be carried out based on the digital tag information by a user.

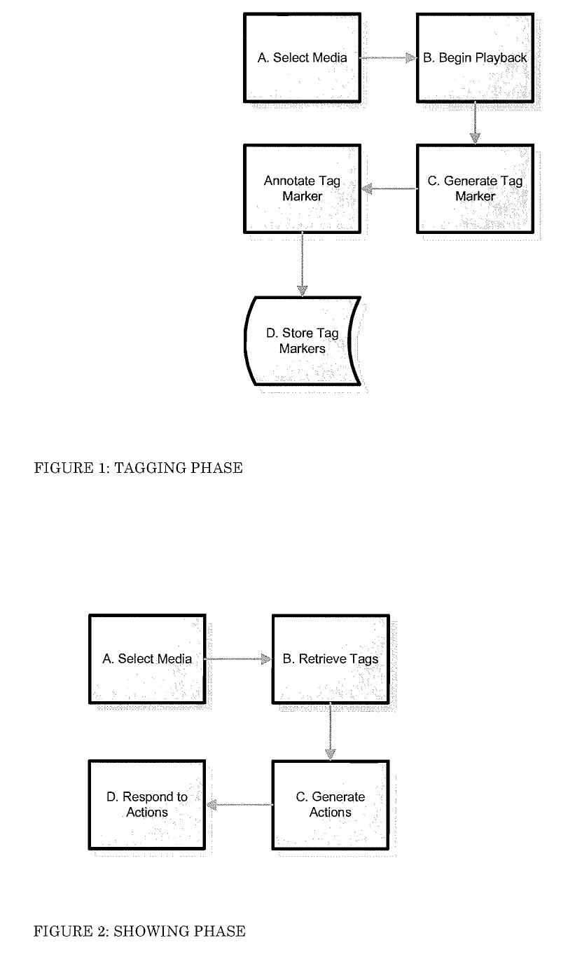

The process Flow for the basic tagging phase is illustrated in FIG. 1. The tagging phase can be performed in a browser for a web application, or as a stand alone application. The media asset can be contained locally, or on any available web site, and “tagged” using a browser-based plug in. The process begins in Step A by selecting a media asset to tag. Tagging begins in Step B by initiating playback of the media asset for the user to view. The media asset can be a movie, video, music video, advertisement, or any other type of time-based visual media file. When the user finds a portion of the media asset to tag, the user generates a tag marker. This can be done either through the use of a graphical user interface or by the use of software methods. The tag marker contains a time code that marks the starting time position in the video asset for the tag, optional time codes that serve as additional internal markers, and an optional time code that serves as the end point for the tag marker.

Once the tag marker is generated, the user then proceeds in the step following Step C by annotating it with annotations associated with the content appearing in the frame or frames denoted by the time code(s) of the tag marker. These content annotations can describe the full range of presentable data, including other media assets. This process is also recursive, so the associated information can itself be annotated. Once annotation is complete, the tags are stored in a data repository in Step D. The tagging phase can include the ability for auto-generated software tags to be associated with the media file. Such tags may be generated in XML (as described in the example below) and stored in a relational database.

### Basic Showing Phase

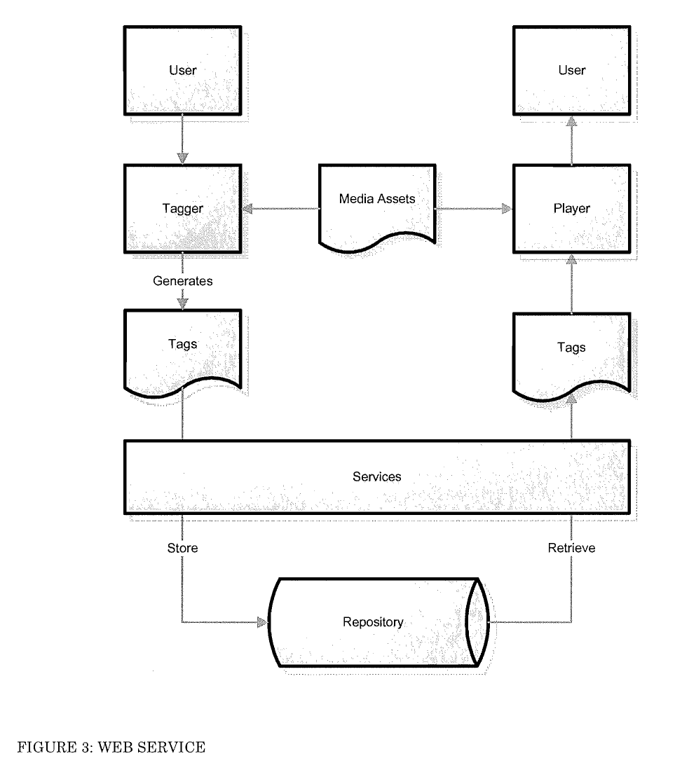

The process flow for the basic showing phase is illustrated in FIG. 2. The showing process begins by the user selecting a media asset or asset type to be shown, in Step A. This occurs within the context of an application that is integrated with a media player, as defined above, or with 3rd party applications that have their own media players. The showing client can be a browser-based plug-in which can display tag assets in a sidebar. When the media asset or asset type has been selected, the player commences a search for specific content in the media asset(s) by inputting search keywords and retrieving keyword-annotated video tag information about the asset(s) in Step B from the data repository. A Web Service can provide the tagging data to online players subscribing to the service, or to 3rd party applications which tie into the service. When the user provides a Video Asset ID, the Web Service responds with the video tag information (as described in more detail in the example below).

The video tag information will be used to generate a display of tagged information and list of possible actions that can be taken as offered by the Web Service in conjunction with the search/display application and/or the media assets. Specifically, each tag can contain at least a starting time code marking the starting time position in the video asset where products or other items of interest are located, an image-still from a frame encompassed by the starting time code, and links to take further actions with respect to products or items appearing in the image still, such as displaying an ad for the item, linking to a vendor website for the item, linking to third party services having a commercial relationship to the item, etc. The search/display application can use this information to provide navigational elements based on item tag information. When the user selects from the possible linkages and options presented, the specified actions will be taken, as indicated in Step C, and the linked function will respond to the actions, as indicated in Step D. Additionally, user monitoring information regarding these actions generated and responded to can be stored in the data repository for possible downstream data mining applications.

In the present invention, an important part of the tagging process is the creation of an image-still photo that is representative of the content of the video frame or segment being tagged, and storing it at a storage address location and retaining only the address location code with the digital tag information. In this manner, the digital tag information can be kept to a small size for quick and easy searching. The digital tag information can be maintained as an all-text file, which avoids the problem of having to maintain mixed (video, graphics and text) file types and also speeds the transmission of the digital tag information to a user device. This is particularly important for mobile user devices having a small memory capacity and a thin browser client. By keeping the digital tag information to a small size and as an all-text file, the video media asset searching service can be extended for searching on mobile user devices, such as PDAs, kiosks, and digital phones.

When a video media asset is being played back for tagging in a web service (or other client-server) environment, creating an image-still may be done on either the browser side, through an applet or plug-in that enables screen capture, or on the server side, through a request from the browser to an image generating service operative on the server. When performed on a local browser, an embedded Java Applet can be configured to designate “where” on the screen display and what dimensions (rectangular coordinates) to perform a screen-image grab. Essentially, this is the area on the page where the embedded video is located. The tagging also includes the time code for the time position of the frame is in the video. Once the image is grabbed, the file for this image can be uploaded to the server, which stores it in its data repository and returns a URL address where the image-still can be accessed for viewing. When performed on the server side, the user can give an image generating service the URL address for the video asset being tagged and the time code position to be captured as an image-still. The server's image generating service accessed the video asset at its URL address, captures the image-still at the designated time code position, stores the image file at a URL address that is resident with or managed by the server, and returns the image-still URL address to the user, such as the following example:
Returned URL: [http://www.moviewares.com/[video_id]/[user_id]/[tag_id].jpg].

Upon the return of the image-still URL address to the user's browser, the user can access the image-still at that URL address and proceed with the tagging process. In a preferred commercial use of the tagging system, the user can input keywords and other annotations identifying products or other items of interest appearing in the image-still, such as items of clothing, popular products, scenes, locations, and/or celebrity persons. These content annotations are stored along with the time code for the tagged frame position and the image-still URL as video tag information or meta data. Storing the image-still URL (rather than an image file) with the meta data allows the meta data file for that tagged frame or video segment to be of small size so that it can be easily stored, searched, and transmitted on a web service.

Creating and storing such video meta data provides a number of advantages. A user during the showing (search/display) phase can search all tagged video assets stored or managed by a video search service using input keywords for items of clothing, popular products, scenes, locations, and/or celebrity persons. The search service then returns hits corresponding to the keywords, along with the associated video meta data including the image-still for the annotated video frame or segment. The search service can display the image-still as a thumbnail photo alongside the search listing, thereby providing the search user with a visual indication of the video content, including items contained therein that may be of interest to the user. Other keywords used to annotate items contained in the image-still may also be displayed as links from that search listing.

Upon the search user clicking on that search listing, image-still, or any of the annotated links, the search service can generate further actions as promoted by that service. For example, if the search service is of the type promoting the purchase of clothing as worn by celebrities, clicking on the thumbnail photo or any annotated links to its contents, the search service can link the user to a display of the item(s) of clothing depicted in the image-still along with advertisements and other commercial information that creates recognition for the designer or vendor of the item(s) of clothing. This provides a potential business model for the tagging/showing service in which advertisers and vendors can subscribe to, pay for, or bid on the rights to link their advertising and other displays to search results provided by the search service.

### Example of Tagging/Showing Web Service

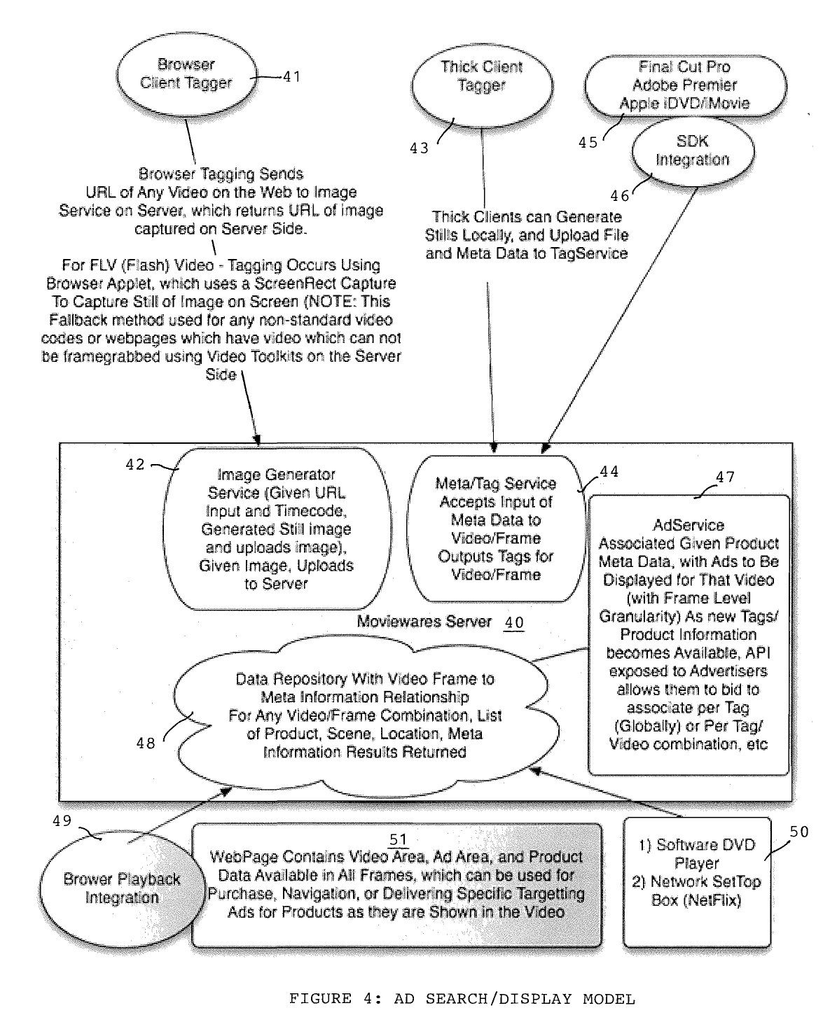

The process flow for a networked or web-based service (“Web Service”) enabling the tagging and showing phases is illustrated in FIG. 3. For the tagging service, the user runs a browser-based tagger client that plays back video media assets and generates tags to annotate content items of interest in them. The video tag information generated is stored by the Web Service in the data repository. For the showing (search/display) service, the user runs a browser-based player plug-in or a player client which queries the Web Service to search for specific content in the media asset(s) and retrieve video tag information about them from the data repository.

Referring to FIG. 4, an example will now be described of the configuration and operation of a preferred form of commercial use of the tagging system for searching and displaying popular items found in movies and videos via a Web Service provided by a “Moviewares Server” 40. In this commercial application, the Web Service enables tagging by users (using thin and/or thick tagging clients), and advertising by various advertisers and/or vendors to be displayed when users find products or other items of interest in their searches of video assets. A Browser Client Tagger 41 is a thin client provided to users to allow them to “tag” video with meta data. The preferred meta data include: (1) frame location; (2) an image-still photo of the frame scene at that location; and (3) keyword(s) describing what is in the frame.

To have image-still capture done on the Server side, the Browser Client Tagger 41 sends a URL for any video addressable on the web and a time code for the frame position of interest to an Image Generator Service 42 operated on the server side. The Image Generator Service 42 performs the image-still capture at the indicated frame position, stores the captured image-still at a unique URL address tracked by the Server, and returns a URL address to the Browser where the captured image-still is stored. When the user has completed annotation of the tagged video frame, the video meta data is uploaded to the Server 40 and stored in its repository 48. As an alternative method, the Browser Client Tagger 41 can perform image-still capture locally using a browser applet employing FLV (Flash) video which uses a ScreenRect capture function to capture the image-still. This alternative is preferred for use in media environments having non-standard video codes or webpages for video that cannot be frame-grabbed using standard video toolkits on the Server side.

Alternatively, the user's client software may be a Thick Client Tagger 43 with a more robust set of video toolkit functions that may be desired for tagging by a commercial entity such as a vendor or advertiser. The Thick Client Tagger 43 can use the video toolkit functions to generate the image-stills locally and upload the image-still file and meta data to a Meta/Tag Service 44 of the Moviewares Server 40. The Meta/Tag Service 44 accepts input of the meta data to the tagged video frame and stores the data in its repository 48.

Meta data can also be created by third-party producer (“Studio”) entities 45 using robust video production tools, including advanced video editing software such as Final Cut Pro, Adobe Premier, or Apple iDVD/Movie. For example, the producer entities can perform pre-tagging of the start positions of important scenes in movies or videos and the image-stills for those positions, and format the pre-tagging data with SDK integration tools 46 provided by the Web Service. The pre-tagging data can then be uploaded to the Server and stored in its repository, for convenient and personalized annotation by clients of the service.

In Appendix I, examples in XML code are shown for a “Search Request”, a “Search Response”, and a “New Tag Request”. The Search Request is composed of a <request> element that contains specific tags which represent the values to be searched. Standard SQL syntax can be used in the element tag values to provide a powerful, flexible search API. The search results can be ordered by Price, Location, etc. In the example shown, the request searches for all Videos/Tags that have “Nike Shoes” “wornBy” “Tom Hanks” or “Brad Pitt”. (Note, removing the wornBy query returns all Nike Shoes worn in all Videos. The Search Response is ordered with the most hits first, and all tags are grouped with their associated video in an ordering that can be specified in the query. The New Tag Request is used for submission of a new tag and addition of a new tagged video asset to the repository is shown in Appendix I. When adding tags to an existing video asset, the user will use the Video ID in a “tag” submit request.

In an example of commercial use shown in FIG. 4, the Web Service is offered as an AdService 47 to which advertisers and vendors can subscribe to, pay for, or bid on rights to associate their advertisements and other information with categories or keywords of the meta data. The ad rights can be broad, limited, and/or extend down to fine-grained levels depending on such factors as value, variety, and popularity, and as new product (tag) information becomes available. Subscriber management tools based on APIs used by the Service can be provided to the advertisers and vendors to subscribe, pay for, or bid on new categories, keywords, or rights levels. The subscriber data and advertisements and other information to be displayed are stored in the Server repository 48 for use during the showing (search/display) phase.

In the search/display phase, a search user employs a Browser 49 to perform searches with the Web Service. Typically, the search user inputs keywords for items of clothing, popular products, scenes, locations, and/or celebrity persons being searched, and the Web Service returns a search Web Page 51 displaying the search results with areas for running the associated video clip and/or thumbnail of the image-still and for advertisements and/or product information. The search page can also provide buttons or tools to facilitate purchasing, navigating, or delivering targeted ads representing or associated with products or items shown in the search listing video or thumbnail photo. For running video, the Browser 49 may be provided with an applet or plug-in tool for playback integration. The Web Service can also provide a related service for searching for and transmitting movie clips, videos, and other visual media stored in its repository 48 (or otherwise managed by its Server 40) to users as interested viewers. User/viewers can connect to the visual media Web Service by streaming to an Internet video viewing site (such as the YouTube™ site) or uploading to a networked playback device 50, such as a software DVD player or a networked set-top box (such as the NetFlix™ set-top box).

The Server 40 for the Web Service manages association of the video tag meta data with vendors and advertisers for the products or items of interest. Each tagged video frame or clip contains product tags, location tags, and/or any keywords a user (regular, or Studio) wants to associate with that frame of video. Once the meta data has been established in the system, any vendor or advertiser can sign up to access and bid on these tags. The back-end Server can list all tagged video frames associated with these tags/products, or select a more fine-grained list based on more detailed parameters. A vendor or advertiser can bid either globally for the duration of video or ad, or more fine-grained for just certain video frame(s), or a certain video producer. For example, the sports equipment company Nike could choose to bid for:
a. Ads for all frames that contain Nike “Air Jordan”™ sneakers.
b. Ads for Kane West video showing Kane West wearing Nike “Air Jordan” sneakers.
c. Ads for playback of Kane West video from a video site.

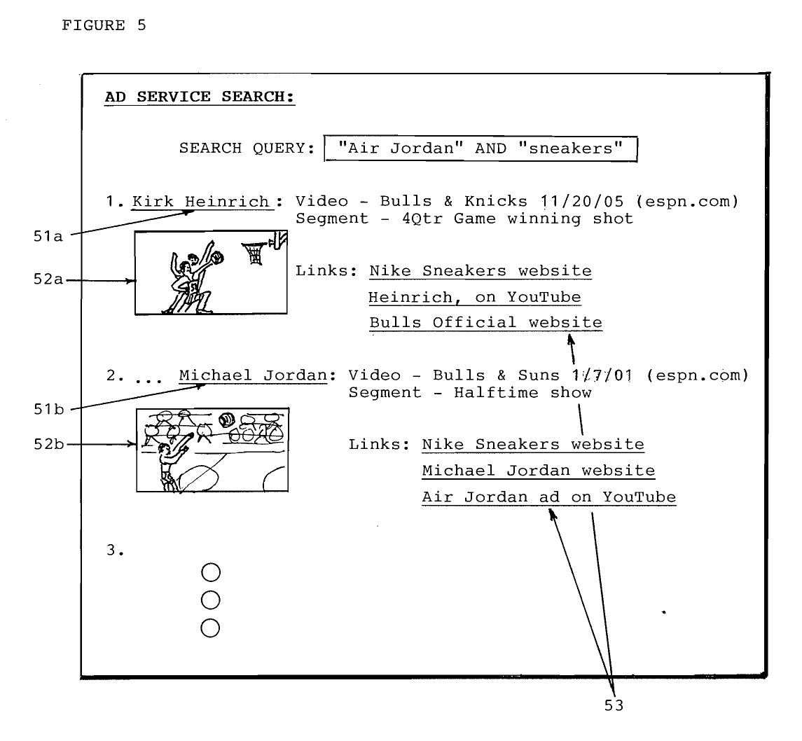

FIG. 5 illustrates an example of a search conducted with an AdService application. A search query was entered for “Air Jordan” AND “sneakers”. The search results list a first entry 51a of a Kirk Heinrich video segment for his 4^{th} quarter game winning shot in the Nov. 20, 2005 Bulls vs. Knicks game while wearing “Air Jordan” sneakers. A thumbnail photo 52a of the image-still at the start of the video segment gives the user a visual reference for the video segment. Advertiser links 53 to the Nike Sneakers website, a Kirk Heinrich video on YouTube™ video service, and the Bulls official website are provided to the user for advertisements and/or product information. Similarly, a second entry 51b lists a Michael Jordan video segment with “Air Jordan” sneakers, thumbnail photo 52b, and related advertiser links 53, etc. For use with small-footprint mobile user devices, the search results may instead display the address code for the image-still, rather than the image-still or a thumbnail photo itself, in order to speed up the return with text-only data and the display of search results. If the mobile user wants to see the image-still, they can then click on the address-code link to download the image-still or thumbnail photo.

Further, the Web Service can allow actual vendors of the products to bid to become the “purchase” site of said product. For instance, Amazon.com could bid to be the preferred provider (submitting the URL of the product) of the item for sale. Sub-vendors can also provide listing for similar products, if the exact product was custom made for the artist/actor. This business method enables a software-based “interchange” for bidding on ad linkages to video assets that is developed much like a stock exchange, or Google's current AdSense system. Clients are enabled to populate and bid/pay for the above tag/ad relationships, which are then served up upon playback to the Web Service's clients.

The Web Service can provide an integrated set of search services based on the tagging system. It can offer open searching based on searching video data repositories for the video meta-data. The search can employ a Boolean search of input keywords, and retrieve the frames of video content having matching keywords. The associated image-still is displayed as a thumbnail for each found frame, and includes a hotspot showing the exact location of the meta-data-tagged product or item. The user can click on a search result (or thumbnail image-still) to link to the vendor who has bid to advertise the item associated with that video/frame/product. Video search data can be provided to partners/licensees who can use this information to build custom taggers, or playback components, or other integration services to provide more targeted ads.

Alternate embodiments for using the tagging/showing methods in other types of user services include the following. In a player-centric version, a user starts by viewing video clips or movie segments searched on the Web Service, and the associated tags are used to push information to the user. For instance, while a user is watching a video clip, they will be able to see the items that are available for sale based on the items currently visible on the screen. Another embodiment is one that is search-based, in which the user starts by searching for a particular type of product, and then advances to view the product in the context of matching media assets. For instance, the user can search for “Britney Spears shoes” and is presented with a list of all catalogued video clips that show shoes that Britney Spears is wearing that are for sale. This method can include integration with an existing media player, to enable uploading from the data repository of the Server along with tags associated with the requested video asset, or to publish the tags through the Web Service to existing applications of other web services using software integration with the providing Web Service.

It is to be understood that many modifications and variations may be devised given the above description of the principles of the invention. It is intended that all such modifications and variations be considered as within the spirit and scope of this invention, as defined in the following claims.

1. A method for tagging a time-dependent visual media asset such as a movie, video, or other visual media file for search and retrieval comprising:
(a) playing back the visual media asset in a time-dependent domain in which a series of time codes identifies corresponding time positions of respective image frames of the visual media asset;
(b) identifying a frame or set of frames of the visual media asset to be tagged with a corresponding time code for at least a starting time position thereof;
(c) capturing an image-still of the identified frame or one of the set of frames for visual depiction of content contained in the frame or set of frames to be tagged;
(d) storing the captured image-still at an address location of a storage repository, and returning an address code for the storage address location;
(e) annotating the content depicted in the captured image-still with one or more keywords representing one or more items or characteristics of items therein; and
(f) storing a tag for the frame or frames as digital tag information for the visual media asset, wherein each said tag includes the time code for at least the starting time position thereof, an address code for the storage address location of the captured image-still of the frame or set of frames, and one or more keywords representing one or more items or characteristics of items of the content in the captured image-still.

2. A method according to claim 1, wherein digital tag information for a multiplicity of visual media assets is stored in a database accessible for searching in response to search queries from users on a network.

3. A method according to claim 2, wherein said searching of said database returns search results to a user, in response to a search request using certain keywords, which contain entries each having an identification of a video segment and a thumbnail photo generated from the captured image-still stored at an address location of said storage repository.

4. A method according to claim 2, wherein each tagged visual media asset is stored in an asset storage repository and can be accessed for playback in response to a search of said digital tag information identifying a particular visual media asset in a search query from a user on a network.

5. A method for computerized searching for items of interest in time-dependent visual media assets, such as a movie, video, or other visual media file, which are tagged with digital tag information comprising:
(a) storing tags with digital tag information for each respective frame or set of frames of the visual media assets tagged as being of interest for searching, wherein each tag includes the time code for at least a starting time position thereof, an address code for a storage address location of a captured image-still of the frame or set of frames, and one or more keywords representing one or more items or characteristics of items of content in the captured image-still;
(b) entering a search request to search the stored digital tag information for the tagged visual media assets using one or more keywords for items of interest in the visual media assets to be searched;
(c) displaying a search result listing entries for those tags found containing keyword(s) for items in the visual media assets corresponding to keyword(s) of the search request, and providing means for viewing the captured image-stills for the respective tags listed as entries of the displayed search result.

6. A method according to claim 5, configured as a web service provided from a server on a network connected to one or more users, said server having an associated data repository for storage of the digital tag information for the tagged visual media assets.

7. A method according to claim 6, wherein said web service includes an advertising service for product items of interest shown in the visual media assets, wherein said advertising service enables advertisers and vendors to display advertisements and other information in conjunction with search results returned in response to search requests from users.

8. A method according to claim 7, wherein said advertising service enables advertisers and vendors to bid for rights to display advertisements and other information in conjunction with search results returned in response to search requests from users.

9. A method according to claim 6, wherein said web service includes a meta tag service for enabling third party entities to produce digital tag information for the visual media assets for storage in the server's data repository.

10. A method according to claim 6, wherein said web service includes an image generator service for generating a captured image-still of a frame or set of frames of a visual media asset in response to a tag request of a user.

11. A method according to claim 6, wherein said web service provides a search result for display in a browser of a user in response to a search request from the user.

12. A method according to claim 6, wherein said web service enables playback of a frame or set of frames of a tagged visual media asset for display to a user in response a user search request corresponding to a tag for the visual media asset.

13. A method according to claim 6, wherein said web service enables playback of a frame or set of frames of a tagged visual media asset for display on a playback device of a user in response to a user search request corresponding to a tag for the visual media asset.

14. A method according to claim 7, wherein said advertising service returns search results to a user in response to a search request using certain keywords which contain entries each having an identification of a video segment, an image-still thumbnail photo from the video segment, and links to advertisers and vendors for advertisements and other information corresponding to the keywords of the search request.

15. A method for conducting an advertising service on a network connected to one of more users with respect to product items of interest contained in time-dependent visual media assets, such as a movie, video, or other visual media file, which are tagged with digital tag information comprising:
(a) storing tags with digital tag information in an associated data repository for each respective frame or set of frames of the visual media assets tagged as containing product items of interest for searching, wherein each tag includes the time code for at least a starting time position thereof, an address code for a storage address location of a captured image-still of the frame or set of frames, and one or more keywords representing one or more product items or characteristics of product items of content in the captured image-still;
(b) enabling product advertisers and/or vendors to link advertisements and other information for product items of interest contained in the tagged visual media assets;
(c) receiving a search request to search the stored digital tag information for the tagged visual media assets using one or more keywords for product items of interest in the visual media assets to be searched; and
(d) displaying a search result listing entries for those tags found containing keyword(s) for product items in the visual media assets corresponding to keyword(s) of the search request, including displaying thumbnail photos generated from the captured image-stills and links to advertisements other information for product items of interest contained in the tagged visual media assets listed in the search results.

16. A method according to claim 15, wherein said advertising service enables advertisers and/or vendors to bid on rights to associate their advertisements and other information with categories or keywords used in the digital tag information.

17. A method according to claim 16, wherein said advertising service enables vendors and/or advertisers to bid optionally for global advertising rights, fine-grained advertising rights, or specific advertising rights to categories or keywords used in the digital tag information.

18. A method according to claim 16, wherein said advertising service enables vendors and/or advertisers to bid to become a “purchase” site for specified product items of interest.

19. A method according to claim 1, wherein the digital tag information is maintained as an all-text file.

20. A method according to claim 15, wherein the digital tag information is maintained as an all-text file.
